(19) United States
(12) Patent Application Publication
(10) Pub. No.: US 2026/0034708 A1
(43) Pub. Date: Feb. 5, 2026

(54) Method and Apparatus for Enhanced Molding of Pre-Cast Structural Components

(71) Applicant: Richard J. Gagliano, Gig Harbor, WA (US)

(72) Inventor: Richard J. Gagliano, Gig Harbor, WA (US)

(21) Appl. No.: 18/790,676

(22) Filed: Jul. 31, 2024

(51) Int. Cl. B28B 7/02; B28B 7/18

(52) U.S. Cl. CPC B28B 7/02; B28B 7/18

(57) ABSTRACT

An insert for use in a mold operation to provide internal cavities and passages within a pre-cast structural component. The insert is a multi-piece elongated tube where the individual pieces slide lengthwise to control the effective cross section. In operation in a form used to cast materials such as concrete, the insert creates a selectively dimensioned passage and is easily discharged from the mold/cast structure during or after the concrete is cured.

### FIELD OF THE INVENTION

The present invention is directed to improved methods and apparatuses that improve the casting process for pre-cast structures and increase operational efficiency and component integrity; and more particularly to methods and apparatuses for building improved foundations for supporting above ground structures.

### BACKGROUND

There is a growing need for improved foundation systems that can support structures above a variety of ground conditions. Traditional foundations involve significant excavation to form deep concrete walled substructures or basements that connect to and support the above ground buildings. These traditional structures have many drawbacks, including damaging the environment and significant costs.

More recently, there have been various engineering developments that address these concerns and improve the foundation systems capable of providing structures effective support without substantial excavation and cost. These systems are described in part in U.S. Pat. Nos. 5,039,256, 6,578,333 and 6,910,832—the contents of each are hereby incorporated by reference as if restated in full.

In particular, reference is made to U.S. Pat. No. 6,910,832 (hereinafter the '832 patent) and the cast concrete footings and methods for forming the same disclosed therein; and specifically the selectively shaped footing or structural body of FIG. 3 depicted in the '832 patent. This footing is created by casting using a form (depicted in FIG. 2 of the '832 patent), where the form is adapted to receive concrete as an uncured fluid into an internal cavity. After the concrete has set, the form is opened and the cast footing released and, upon complete curing, is ready to use. In this arrangement, the passage formed in the footing must be open at two ends and extend at an angle relative to the footing installation. These two openings allow for the pipe pile to be driven into position, penetrating the ground around the footing to secure its position as part of the foundation.

The footing formed by the techniques discussed in the '832 patent requires discrete passages within the concrete to allow the use of driven pipe piles. This is a sleeveless design (see FIG. 5 of the '832 patent). To install the footing or structure, elongated steel pipe piles are driven into and through the passages in the footing at selected angles to engage the surrounding soil and support the footing under specific loads.

Because these passages within the concrete footing are sleeveless (i.e., no internal secondary tubular components), the passage dimensions are formed during the casting process and controlled by the use of tapered “inserts” into the form. These inserts are placed into the form before the pour of concrete; once the inserts are properly positioned, the concrete mix is poured into the form. As the concrete begins to set, the inserts are rotated about their longitudinal axis so that they remain free from the curing concrete. Once the curing is mostly complete, the inserts are removed leaving passages within the footing that are sized to receive pipe piles during installation.

Originally, the design of the inserts used to create pipe pile passages involved an elongated single piece insert tapered along its length. The taper of the insert is used to facilitate removal of the insert after curing. By rotating and tapping the small end extending outside the form after the curing process is done, the insert can be coaxed out of the passage and separated from the footing.

Use of a tapered insert can create problems. The pipe pile that is ultimately used during the installation of the footing has a substantially constant diameter along its length. The pipe pile diameter therefore must be no greater than the diameter of the narrower end of the insert. The diameter of the wider end of the insert is larger than the diameter of the pipe pile. This leaves a small gap between the pipe pile and passage wall of the footing after the pipe pile is installed for some of its length. If this gap is too large it may reduce the quality and/or stability of the foundation.

Additionally, the use of tapered inserts in pre-cast structural elements such as footings can complicate the manufacturing process. If the insert isn't properly freed from the cured concrete it cannot be removed rendering both the form and cast material useless. The precise timing of removing the insert from the curing concrete is a variable that is often difficult to predict as it depends on the ambient conditions during curing. Moreover, manufactured inserts often have surface imperfections along their length that can bind to the concrete as it cures. If the insert binds in the passage, due to these surface imperfections or other reasons, and cannot be removed, both the form and cast structure are lost. Removing or smoothing the imperfections on the tapered inserts, while reducing this tendency to bind, also reduces the effective insert cross section often rendering it too small to create the desired passage.

Therefore, there is a need for improved insert design solutions which address the issues identified above. These solutions address specific issues with regard to foundation footings. They may also be advantageously applied in different pre-cast structural elements. The basic inventive concepts are escribed below with foundation footings as the illustrative example.

### SUMMARY OF THE PRESENT DISCLOSURE

An object of the present invention is to provide a method of manufacturing pre-cast structures that include passages having tightly controlled dimensions.

It is another object of the present invention to provide a form (or mold) insert having adjustable dimensions to facilitate the formation of properly dimensioned passages within pre-cast structures.

It is yet another object of the present invention to provide a form insert having surface characteristics that allow facilitated removal from a cast structure post curing.

It is still another object of the present invention to provide a form insert that can be adjusted to fit forms and establish passages of variable dimensions.

It is yet another object of the present invention to provide a method of manufacturing a form insert from a tubular starting material that is shaped into two symmetrical pieces.

It is another object of the present invention to provide an adjustable two-piece form insert that can be slidingly shaped into a single insert having a defined well controlled cross section.

The above and other objects of the present invention are realized in a method for constructing inserts having specific features, the use of specialized inserts in the forms used for molding pre-cast structures, the method of releasing inserts from forms during or after the curing of concrete or other materials used in pre-cast structures, and the resulting structures with tightly controlled dimensions for passages therein created by casting with selectively engineered inserts.

In accordance with the varying features of the present invention, a method of making the individual inserts is provided. Specifically, starting with a symmetrically shaped component such as an elongated cylindrical tube with a uniform cross-section and central bore extending its full length, a flat cut is made end to end at a pre-selected angle. This cut removes a selected thickness of material so that the two halves, taken together, have a cross-section reduced from its starting dimension but individually tapered along their lengths.

Prior to use, these two halves are mated but offset by an amount that results in a cross section that substantially matches the desired starting dimensions, D, before the cut. This cross-section also matches or is slightly larger than the cross-section of the pipe pile used later for installation. The size of the bore in the starting tube is controlled to provide both good wall strength for the final insert and reduced friction on the internal surfaces along the cut to facilitate easy sliding.

Once properly configured, the final insert (combining both halves) is placed into the form and with ends extending out of the openings defining the location of the insert in the form. These openings will match the cross-section of the offset insert assembly. Any surface imperfections that may develop on the outer surface of the insert run along the length of the insert. To facilitate linear removal of the insert, imperfections on the surface that exist orthogonally to the length of the insert are minimized.

After multiple uses, the outer surface imperfections can be removed; while this would reduce the effective cross-section, because the two opposing inserts can be adjusted by sliding, the desired cross-section can be re-established even after some material has been removed by surface smoothing.

The mold is then filled with a curable fluid such as concrete, which is allowed to set and harden around the final insert. If needed, the use of a two-piece insert allows for excess curable material to flow through the small seam along the insert and into the bore between the two insert components. This residue can flow out of the final insert and mold via the bore opening. This bore also can be supplied with water at a different temperature to control the mold/insert temperature at that location, and improve final insert release.

The final insert is thereafter removed by tapping its tip gently, releasing the two halves that drop out of the mold, leaving a tightly tolerance passage having a uniform cross section for its full length. For the foundation footing application, the passage receives a pipe pile having a slightly smaller cross-section during installation in the ground. On installation, the small tolerance between the cured concrete passage and the pipe pile limits play.

In a preferred arrangement, the final insert is formed by two nearly identical halves, or “Insert Components,” and the insert is assembled by aligning the two Insert Components juxtaposed lengthwise along one surface but oriented in opposing taper directions.

Additional advantageous features, functions, and applications of the disclosed systems, methods, apparatuses and assemblies of the present disclosure will be apparent from the description which follows, particularly when considered in conjunction with the Figures. All references listed in this disclosure are hereby incorporated by reference in their entirety.

### BRIEF DESCRIPTION OF THE DRAWINGS

The following descriptions should not be considered limiting in any way. With reference to the accompanying drawings, like elements are numbered alike:

FIG. 1A is a perspective view of an illustrative starting shape for constructing an insert according to an embodiment of the present invention;

FIG. 1B is a side elevation view of the insert mold of FIG. 1A according to an embodiment of the present invention;

FIG. 1C is an alternate side elevation view of the insert of FIG. 1A according to an embodiment of the present invention;

FIG. 1D is an alternate side elevation view of the insert of FIG. 1A according to an embodiment of the present invention;

FIG. 2A is a cross-sectional view of the insert of FIG. 1B taken along line 2A-2A at according to an embodiment of the present invention;

FIG. 2B is a cross-sectional view of the insert of FIG. 1B taken along line 2B-2B at according to an embodiment of the present invention;

FIG. 2C is a cross-sectional view of the insert of FIG. 1B taken along line 2C-2C at according to an embodiment of the present invention;

FIG. 3A is a perspective view of a mold with two openings (one visible).

FIG. 3B is a side elevation view of a mold for use with an insert according to an embodiment of the invention;

FIG. 3C is a schematic representation of the openings of the mold of FIGS. 3A and 3B according to an embodiment of the present invention;

FIG. 4A is a side elevation view of an insert according to an embodiment of the present invention;

FIG. 4B is a cross-sectional view of the insert of FIG. 4A according to an embodiment of the present invention;

FIG. 5A is a side elevation view of an insert according to an embodiment of the present invention;

FIG. 5B is a cross-sectional view of the insert of FIG. 5A according to an embodiment of the present invention;

FIG. 6A is a side elevation view of an insert according to an embodiment of the present invention; and

FIG. 6B is a cross-sectional view of the insert of FIG. 6A according to an embodiment of the present invention.

### DETAILED DESCRIPTION OF THE PREFERRED EMBODIMENTS

A detailed description of one or more embodiments of the disclosed apparatus and method are presented herein by way of exemplification and not limitation with reference to the Figures. The various features, steps, and combinations of features and steps, described herein and illustrated in the Figures, being organized in different combinations and permutations is within the scope of the present disclosure and contemplated herein.

It will be understood that the Figures are non-limiting and are for the purpose of describing particular embodiments of the disclosure and are not intended to limit the same. It is further understood that elements in the referenced Figures are not necessarily depicted to scale and may have been exaggerated for purposes of clarity.

The present invention is directed to a facilitated mold/cast operation using inserts to create selective features within a pre-cast structure. The following illustrative example is directed to a foundation footing design where inserts are used in the molding process to establish passages of controlled dimensions within the casting to permit the insertion of elongated pipe piles when a foundation system is installed. Reference is made to U.S. Pat. No. 6,910,832, wherein a molding process, mold and final cast footing are disclosed. In this arrangement, the passage formed in the footing is open at two ends and extends at an angle relative to the footing installation. These two openings allow for the pipe pile to be driven into position, penetrating the ground around the footing to secure its position as part of the foundation.

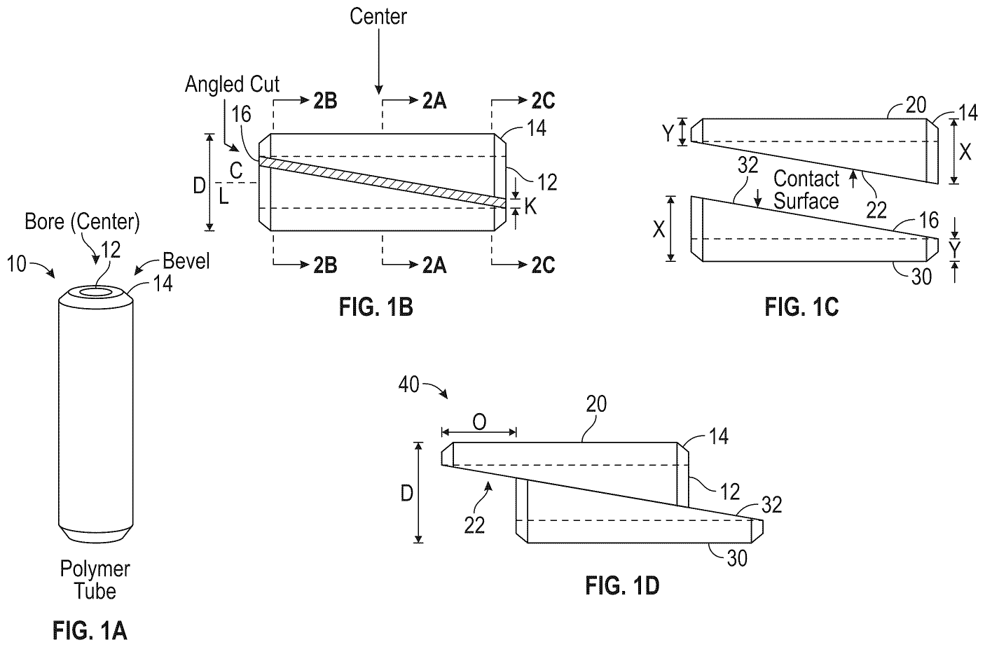

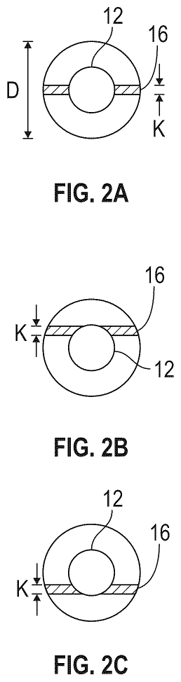

With reference now to FIGS. 1A-D, an insert according to an exemplary embodiment is illustrated at 10. Insert tube 10—a starting point—is illustrated at FIG. 1A. Insert tube 10 may be a polymeric extruded tube having an internal bore 12 concentric with the outer circumference of the insert tube 10. The outer circumference of the insert tube 10 may be substantially uniform in a preferred arrangement. Although the insert tube 10 is illustrated as being cylindrical or generally cylindrical in shape, embodiments where the insert tube 10 has another cross sectional shape are also contemplated herein. Furthermore, it is contemplated that the insert tube 10 may be formed using a material other than a polymer suitable for use as insert as described herein, and may be formed through a process other than extrusion suitable for the material used, for example injection molding or additive manufacturing (3D printing).

In the illustrated non-limiting embodiment, each end of the starting tube 10 is beveled at 45 degrees although beveled edges 14 may be beveled between 15 degrees and 75 degrees in certain arrangements.

In the illustrative non-limiting embodiment, a straight angled cut 16 is made lengthwise from one end of the starting tube 10 to the other, bisecting the starting tube 10 into a first part 20 and a second part 30. The angled cut 16 is typically at a lower acute angle, e.g., 5-10 degrees starting above a center line running lengthwise, and ending below the center line; Other angles can be used, provided the angled cut bisects each opposing end of the starting tube 10.

Each part 20, 30 may have a partial bore 12 running the length of the respective part 20, 30 of the starting tube 10. The depth of the bore 12 may vary for each part 20, 30 along the length of the part 20, 30, from a reduced cross-section radius to almost a complete circle, depending on the angle of the angled cut 16. In the illustrated non-limiting embodiment, the parts 20, 30 of the starting tube 10 are symmetrical, resulting in equal but opposing dimensions X and Y at each end of the parts 20, 30 with opposing orientations, is this way part 20 is substantially identical to part 30.

The angled cut 16 may remove a thickness of material “K” from the cross section of starting tube 10 thereby reducing the effective diameter of the two parts 20, 30 to be D′; D′ is also the sum of the remaining dimensions for the two parts after the cut, i.e., D′=D−K and D′=X+Y.

With reference to FIGS. 1C and 1D, the internal surfaces of starting tube 10, exposed by the angled cut 16 become contact surfaces 22, 32 having a low frictional value that allows easy sliding between the parts 20, 30 along the length of the starting tube 10. The application of a larger diameter of the bore 12 may also reduce the area of the contact surfaces 22, 32 thereby further reducing the lateral friction between the parts 20, 30 and thus allowing lower frictional movement along their length when assembled.

The two parts 20, 30 may be assembled into an offset position defined by an offset distance “O”, as illustrated in FIG. 1D. This assembly is the final insert, 40. The offset O may alter the diameter of the final insert 40 from D′ (i.e., post angled cut 16 and removal of material K) to D thereby returning the diameter to that of the staring insert tube 10, i.e., a diameter D notwithstanding the removal of material by the angled cut 16 of thickness K. The offset O may be based on the angle of the angled cut 16 and the removed material K such that the effective diameter of the final insert 40 is a diameter D.

Alternatively, the tapered shaped parts 20, 30 as illustrated in FIGS. 1A-D may be made individually, by machining blocks into the requisite tapered cross section with a central channel or by molding followed by trimming/machining the part. Other shapes and manufacturing approaches may be used without departing from aspects of the present invention, such as three dimensional printing or extrusion casting.

Furthermore, one or more of the following properties may be achieved with the following approaches, which may be advantageous in certain applications of the present invention. External and internal surface defects on the starting tube 10 may be minimized using lengthwise processing. Lengthwise processing may minimize lateral external defects, which cause increased friction in the longitudinal direction when the final insert tube 40 is removed from the form after concrete curing, and may minimize lateral internal defects, which cause increased friction in the longitudinal direction between parts 20, 30. The final insert 40 may be lengthened by adjusting the angle of the angled cut 16 to be smaller (i.e., closer to horizontal). The requisite offset O to return the final insert 40 to the starting diameter D may be reduced by decreasing the thickness of material removed K. Insertion of the final insert 40 into the form/cast may be facilitated by the presence of beveled edges 14 and may be further facilitated by increase the angle and depth of the bevel. The thickness of the walls of the starting tube 10, i.e., the diameter of the bore 12 may be adjusted as necessary to balance retaining the shape of the final insert 40 during the mold operation within the form/cast and reducing friction between the contact surface 22, 32.

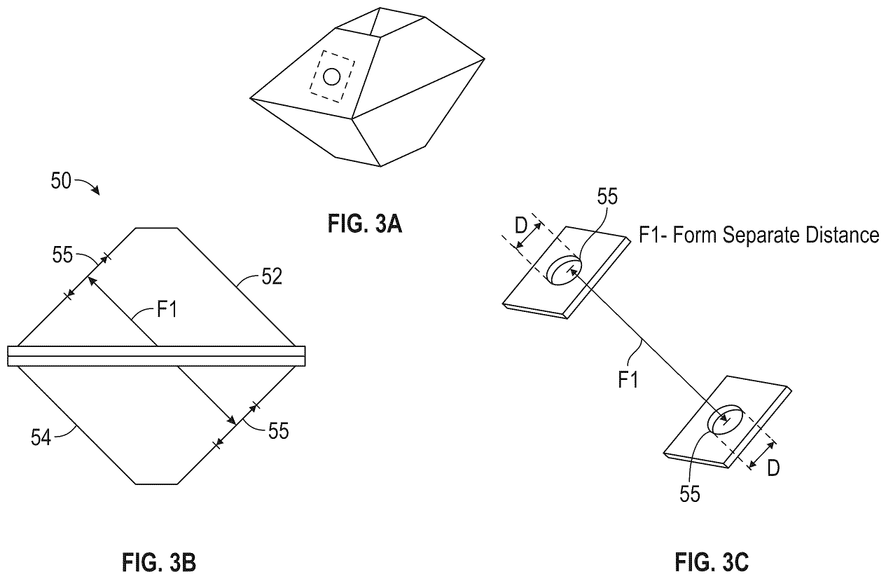

Referring now to FIGS. 3A-C, s a two piece mold form 50 is depicted according to an exemplary embodiment. As shown in FIG. 3B, the mold form 50 may be made of two clam shell parts 52, 54 held together to form a selectively shaped molding cavity. While there is substantially more detail in an operative mold, for purposes of this illustration, the limited mold features are shown including the two opposing openings 55 in each of the clam shell parts 52, 54 for receiving and positioning the final insert 40 into the mold form 50. The mold form 50 may have additional sets of openings to support additional inserts. This arrangement of the openings 55 is depicted in FIG. 3C separated from the mold 50, defining the distance F1 between the two openings 55. Each opening 55 may have a diameter D, i.e., the same diameter as the final insert 40, as illustrated in FIG. 3B.

In an alternate the embodiment the openings 55 may have a diameter that is larger or smaller than diameter D. In this embodiment the offset O of the parts 20, 30 may be adjusted to vary the diameter of the combination of parts 20, 30 to match the diameter of the openings 55. In this way the same parts 20, 30 can be used in multiple mold forms 50 having different diameter openings 55 by adjusting the offset O. For example, increasing the offset O may increase the diameter of the combination of parts 20, 30 to be larger than the initial diameter D of the insert 40 and decreasing the offset O to be a negative value (relatively) may result in a substantially smaller diameter than diameter D′.

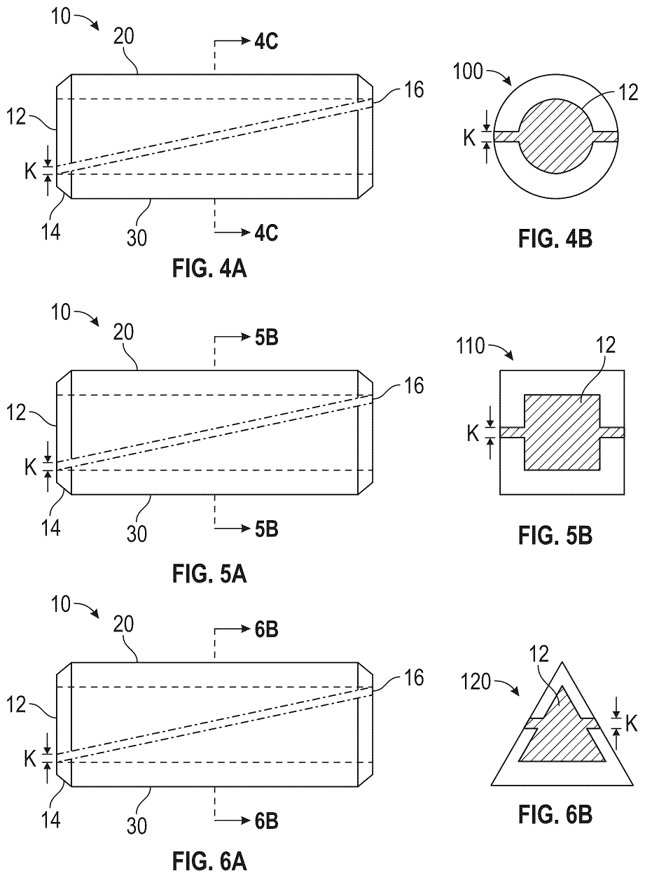

In exemplary embodiments the starting insert 10 may have alternate geometry useful in creating inserts in accordance with the present invention, e.g., as illustrated in FIGS. 4A-B, 5A-B, and 6A-B. Three separate cross sections are shown, each having one or more levels of symmetry about the centerline of the starting insert 10. These are a circle 100 (4A-B; other ellipse configurations are also alternatives); square 110 (5A-B; other rectangle configurations are also alternatives) and triangle 120 (6A-B)—each with a matching internal bore. It is understood that there may be additional alternate geometries of the insert 40 having one or more levels of symmetry about the centerline of the insert 40.

In an embodiment having one or more levels of symmetry, insert tube 10 with a uniform cross-section and central bore 12 extending its full length, an angled cut 16 may be made end to end at a pre-selected angle. The angled cut 16 may remove a selected thickness of material K so that the two parts 20, 30, taken together, have a cross-section D′ reduced from its starting dimension but individually tapered along their respective lengths.

Prior to use, these two parts 20, 30 may be mated with an offset O, before the angled cut 16. This cross-section may also match or may be slightly larger than the cross-section of the pile used later for installation. The size of the bore 12 is controlled to balance wall strength for the insert, the mated parts 20, 30, and reduced friction between the contact surfaces 22, 32 along the angled cut 16 to facilitate sliding of the parts 20, 30.

Once configured, the parts 20, 30 may be placed into the form mold 50 with ends of the parts 20, 30 extending out of the openings 55 defining the future location of the pipe pile used later for installation. These openings 55 may match the cross-section of the parts 20, 30 with an offset O and may be a distance F1 apart. Any surface imperfections on the outer surface of the parts 20, 30 that are orthogonal to the length of the parts 20, 30 are minimized to facilitate removal of the parts 20, 30. In an embodiment surface imperfections that run along the length of the parts 20, 30 may be left as these imperfections may not substantially impact the function of the parts 20, 30. Where surface imperfections need to be removed this can be done by smoothing the outer surface. To retain the original cross-section after smoothing where material is removed, the offset is slightly increased which increases the cross-section to the desired diameter.

The mold 55 may then be filled with a curable fluid, such as concrete, which sets and hardens around the parts 20, 30. The parts 20, 30 may thereafter be removed by tapping the protruding end of each part 20, 30 gently, releasing the two parts 20, 30 to drop out of the mold, leaving a tightly tolerance passage having a uniform or substantially uniform cross section for its full length F1. In an exemplary embodiment for a foundation footing application, the passage may receive a pipe pile having a slightly smaller cross-section than diameter D along the length F1 of the passage during installation that limits play.

In an embodiment parts 20, 30 may be identical or nearly identical halves, or “insert components,” of an insert, whereby the insert is assembled by aligning the two halves juxtaposed lengthwise along one surface but oriented in opposing directions. Where two identical halves are provided, one is rotated 180 degrees to mirror the opposite corresponding half and assembled into the complete insert. This may also advantageously allow for each part 20 to be replaced/used interchangeably for part 30. Use of a two-part insert may allow the excess curable material to flow through the small gap/seam between the parts 20, 30 and into the bore 12. The curable material may be washed or rinsed out, and/or may simply drop out of the bottom through the bore 12.

In an embodiment the final insert 40 or the parts 20, 30 may be heated or cooled to expand or contract the insert 40 or parts 20, 30. Additionally, an opposite temperature change may cause the final insert 40 or the parts 20, 30 to contract and facilitate removal after the curable material sets and hardens. For example, water (or other fluids) of different temperatures may be run through the bore 12 to change the temperature of the insert 40 or the parts 20, 30. Additionally, the curing and extraction post curing process may take place in a temperature controlled environment. The respective temperature change, i.e., heating or cooling, used at each stage, i.e., curing or extraction, may advantageously depend on the selected coefficient of thermal expansion of the material of the final insert 40 or the parts 20, 30.

The illustrative arrangements and methods of use provided herein describe in detail the features and benefits of selected embodiments of the invention but are not intended to limit the inventions.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An apparatus for placement into a form for use to mold a structural component and to create internal passages within said structural component after casting with a curable material, said apparatus comprising:
A multi piece elongated insert wherein at least one piece has a substantially uniform taper along its length, a substantially semi-circular cross section with central tapered groove extending lengthwise for a portion of its length, wherein plural pieces are configured to slidingly engage each other to establish substantially equal cross-sectional dimensions located at least at two locations along its length.

2. The apparatus of claim 1 wherein said multi-piece insert is comprised of pieces that are substantially the same shape.

3. The apparatus of claim 2 wherein said multi-piece insert is comprised of two pieces arranged with opposing tapers.

4. The apparatus of claim 3 wherein said two pieces have beveled ends

5. The apparatus of claim 2 wherein each piece is formed from a polymer.

6. The apparatus of claim 6 wherein each piece has minimal surface defects and provide low friction surfaces along the length thereof.

7. The apparatus of claim 2 wherein each piece provides a thickness of the wall formed by said groove sufficient to minimize bending during a casting operation.

8. The apparatus of claim 1 wherein said insert is discharged with minimal force after said casting is complete.

9. The apparatus of claim 8 wherein said insert establishes a substantially constant cross-sectional passage within said cast structural component.

10. The apparatus of claim 8 wherein said insert establishes a passage within said structural component that substantially corresponds to the cross section of one or more pipe piles.

11. A pre-cast structural component, comprising one or more internal passages extending through the component with a substantially uniform cross-section, wherein said passages connect to the outer surface of the component with openings; and
whereby the passages in said structural component are established during a molding operation by the use of a two-piece insert that has a substantially uniform cross section during the molding operation and where said insert is released from the pre-cast component with minimal force applied to one end of the insert after the casting is complete.

12. The pre-cast structural component of claim 11, wherein said component is a foundation footing comprising plural sleeveless passages set at pre-selected angles each extending though the footing with a substantially uniform cross-section and configured to allow passage of an elongated pipe pile having a similar substantially uniform cross-section, wherein said passages connect to the outer surface of the footing with openings that substantially match the cross section of the elongate pipe pile.

13. The pre-cast component of claim 12 wherein said footing is cast from cement and said pipe piles are made of steel.

14. A mold insert for a pre-cast structural foundation element, comprising:
an elongated insert main body which includes:
a first wedge-shaped segment defining a portion of an outer periphery for the insert and including a first sliding surface running lengthwise of said insert and formed at an angle with respect to an axis for the insert; and
a second wedge-shaped segment defining a remaining portion of the outer periphery for the insert and including a second sliding surface which is positioned adjacent to the first sliding surface; and
wherein the first wedge-shaped segment is configured to slideably engage said second wedge-shaped segment along their respective sliding surfaces whereby a cross-sectional dimension taken perpendicular to the axis for the insert is adjustable upon sliding.

15. The mold insert of claim 14, wherein said cross-sectional dimension is increased to a desired passage dimension for the mold by sliding said segments to a relative positional offset.

16. A pre-cast structural foundation element molded using the insert of claim 14.

17. An Insert Component for use in creating an insert, wherein said insert is used to establish a controlled cross-sectional passage within a pre-cast structure, said Insert Component comprises:
A first selectively shaped portion of an outer surface extending lengthwise along the insert component; and
A flattened sliding surface extending lengthwise along a second portion of the outer surface of the insert component, wherein a cross-sectional area of the insert component is gradually reduced along its length.

18. The insert component of claim 17, wherein the selectively shaped portion is generally cylindrical.

19. The insert component of claim 18, wherein the pre-cast structure is a foundation footing and the passage is configured to receive a driven pipe pile that has a cross-section that substantially matches the cross-section of the passage.

20. The insert component of claim 17, wherein said second portion of the outer surface further comprises a tapered groove along its length.
